(19) United States
(12) Patent Application Publication
(10) Pub. No.: US 2016/0295313 A1
(43) Pub. Date: Oct. 6, 2016

(54) Wireless Headphone Device

(71) Applicant: Sharon Martin, Hugo, OK (US)

(72) Inventor: Sharon Martin, Hugo, OK (US)

(21) Appl. No.: 15/085,071

(22) Filed: Mar. 30, 2016

Related U.S. Application Data
(60) Provisional application No. 62/140,763, filed on Mar. 31, 2015.

(51) Int. Cl. H04R 1/10

(52) U.S. Cl. CPC H04R 1/1041; H04R 1/1008; H04R 2420/07; H04R 2420/09

(57) ABSTRACT

A wireless headphone device for use in playing audio from external memory storage devices and wireless remote electronic devices via speakers. The wireless headphone device includes one or more headphone housings having a wireless transceiver that can receive audio data wirelessly from a remote electronic device. Additionally, at least one of the headphone housings includes a user input port for receiving an external memory storage devices. A controller having one or more buttons is positioned on one or more of the headphone housings and controls playback of the audio data from the coupled external memory storage device and remote electronic device. A rechargeable power source provides electrical power to the wireless headphone device enabling wireless usage. In an embodiment, the wireless headphone device includes a first and second headphone housing connected by an extendable headband that may be positioned over a head of a user.

### CROSS REFERENCE TO RELATED APPLICATION

This application claims the benefit of U.S. Provisional Application No. 62/140,763 filed on Mar. 31, 2015. The above identified patent application is herein incorporated by reference in its entirety to provide continuity of disclosure.

### BACKGROUND OF THE INVENTION

The present invention relates to wireless headphones. More specifically, the present invention relates to a wireless headphone device comprising a first headphone housing and a second headphone housing connected via headband that is configured to be placed over a head of a user. The wireless headphone device enables both a physical connection between an external memory storage device and a wireless connection between a remote electronic device, wherein audio and media data may be communicated therebetween.

Many attempts have been made to provide headphones that are capable of receiving audio and media data from various devices having memory storage. However, standard wired headphones, for example, do not allow for the wireless transfer of audio and media data from a mobile electronic device. These known devices require a wired connection that necessitate both the headphones and electronic device to remain in close, unobstructed proximity for the continuous flow of audio and media data to the headphones. Further, these wires may become tangled or damaged, leading to decreased audio quality, possibly with frequent interruptions, and can be particularly cumbersome while engaging in physical activities.

Further, conventional wireless headphones fail to provide a user input port configured to receive physical external memory storage in such a way that audio and media files may be played through the headphone speakers. In addition, these known headphones lack internal memory storage for the storing of audio and media files for playback at a desired future date. In addition, both wired and wireless headphones fail to provide actuatable buttons that control the playback settings of the audio and media data positioned on the headphone housing.

While engaging in various activities such as walking, relaxing, or other similar activates, many individuals enjoy listing to music, audible books, and the like. It is common that these individuals will utilize headphones as their preferred listening device that are worn on one's head and provides music or other audio directly to one's ear. Thus, it is desirable to provide a wireless headphone device that enables a physical connection between external memory storage devices and a wireless connection between an electronic device, wherein audio and media data may be communicated therebetween. It would be further desirable to provide a wireless headphone device that provides a controller disposed on at least one of the headphone housings that enables users to selectively control the audio and media data playback settings.

### SUMMARY OF THE INVENTION

In view of the foregoing disadvantages inherent in the known types of wireless headphone devices now present in the prior art, the present invention provides a wireless headphone device wherein the same can be utilized for playing media and audio data from a wireless and wireless connection.

The present invention relates to a wireless headphone device comprising one or more headphone housings connected via a headband that is configured to be placed over a head of a user. At least one of the headphone housings include a control circuit operably connected to at least one audio speaker, at least one wireless transceiver, at least one user input port, and a controller disposed therein, and wherein the controller comprises at least one actuatable member.

It is therefore an object of the present invention to provide a new and improved wireless headphone that has all of the advantages of the prior art and none of the disadvantages.

It is therefore an object of the present invention to provide a wireless headphone device that wirelessly connects to a remote electronic device via wireless transceiver and includes an integral power source, such as a battery, that provides electrical power the device.

It is therefore an object of the present invention to provide a wireless headphone having a headphone housing comprising actuatable buttons and switches that control playback functions and other function.

It is therefore an object of the present invention to provide a wireless headphone comprising an extendable headband disposed between a pair of headphone housings, wherein each headphone housings include a speaker and cushion configured to comfortably fit over an ear of a user.

It is another object of the present invention to provide a wireless headphone that utilizes an external power source to power at least one headphone housing and charge the onboard power source.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the present invention.

FIG. 2 shows a perspective view of one embodiment of the present invention with external memory being attached.

FIG. 3 shows a side view of one embodiment of the present invention.

FIG. 4 shows a schematic diagram of one embodiment of the present invention.

FIG. 5 shows an exemplary flowchart of one process used to implement the functionality provided by the present invention.

### DETAILED DESCRIPTION OF THE INVENTION

Reference is made herein to the attached drawings. Like reference numerals are used throughout the drawings to depict like or similar elements of the firearm attachment. For the purposes of presenting a brief and clear description of the present invention, the preferred embodiment will be discussed as used for playing audio and media data from a wireless headphone device having wireless and wired functionality. The figures are intended for representative purposes only and should not be considered to be limiting in any respect.

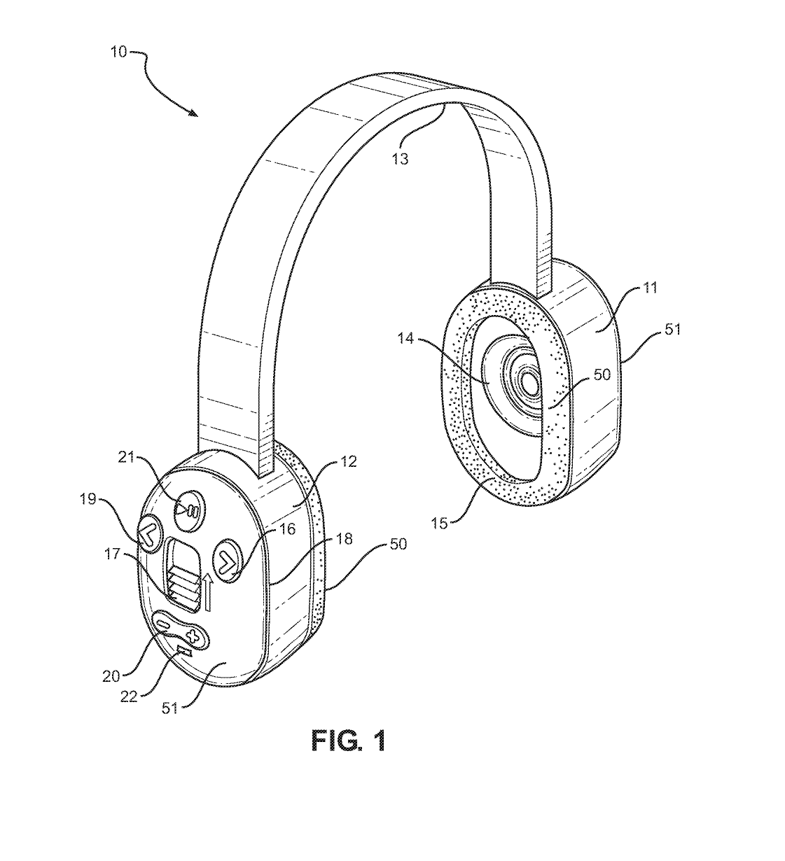

Referring now to FIG. 1, there is a perspective view of one embodiment of the present invention. The present invention provides a wireless headphone device 10 wearable on a head of a user and configured to play audio data. The wireless headphone device 10 comprises one or more headphone housings 11, 12 having at least one audio speaker 14 for producing audible sound. The audio speakers 14 are directed towards a user and sized to enable sound to be heard by the user when audio data are provided thereto.

In the shown embodiment, the wireless headphone device 10 comprises a first headphone housing 11 connected via a headband 13 to a second headphone housing 12. The headphone housings 11, 12 comprise a proximal side 50 and a lateral side 51, wherein the proximal side 50 includes an open end that provides access to an interior volume positioned adjacent to the speaker 14. The interior volume is configured to receive an ear of a user therein. The headband 13 is configured to be placed over a head of a user such that the first and second headphone housings 11, 12 are positioned over respective ears of the user. In the shown embodiment, the headband 13 is constructed from an elongated plastic strap having the first and second headphone housings 11, 12 disposed at the opposing ends.

The wireless headphone device 10 further comprises a control circuit operably connected to at least one wireless transceiver (not shown), and a controller 18 having at least one actuatable member. The actuatable members provide a user different playback control function of the audio data. In the shown embodiment, the actuatable members of the controller 18 include an activation switch 17, a next button 16, a previous button 19, a play button 21, a volume control button 20, and a user input port 22. The next and previous button 16, 19 enables a user to select the next or previous track of the audio data to be selected by respective operation thereof. These actuatable members are disposed on the lateral side 51 of the housing 11 and may include recesses and protrusions indicating and distinguishing the actuatable members from each other. In one embodiment, the first headphone housing 11 and the second headphone housing 12 are substantially similar. However, in alternative embodiments, the headphones housings 11, 12 have a different configured. For example, the first headphones housing 11 includes the speaker 14, wireless transceiver, and controller 18, and the second headphone housing 12 includes a speaker that is operably connected to the first housing 11.

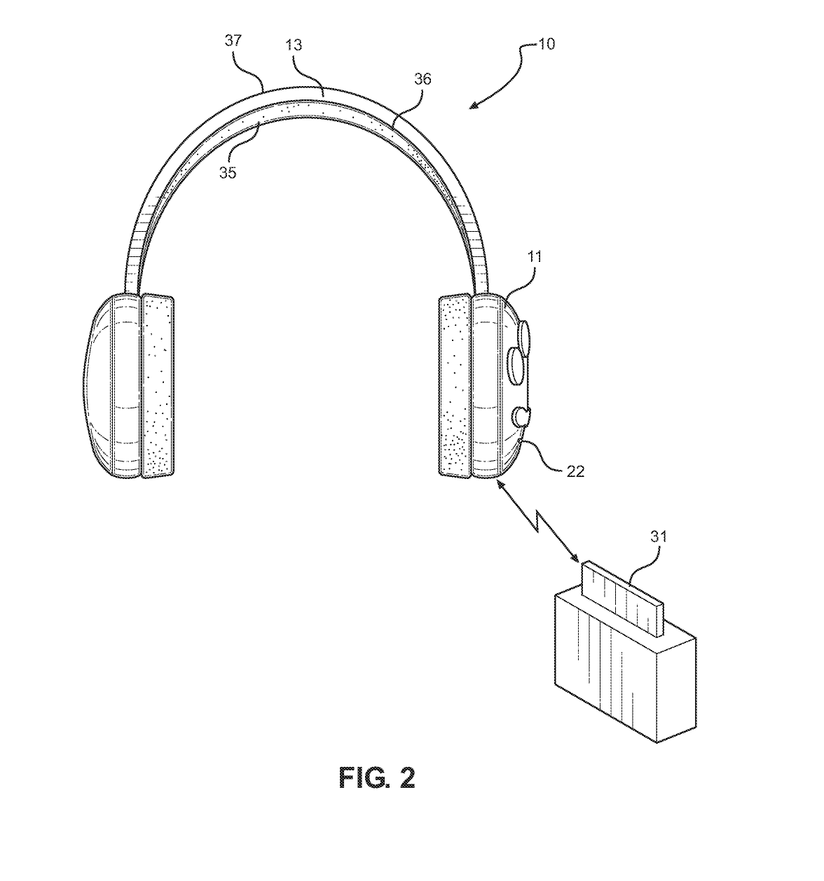

Referring now to FIG. 2, there is a perspective view of one embodiment of the present invention with external memory being attached. The user input port 22 of the headphone housing 11 is configured to receive an electrical connector 31 from an external memory storage device 31. In the shown embodiment, the external memory storage device 31 is being physically coupled to the user input port 22 of the headphone housing 11 to allow electronic communication therebetween. In one embodiment, the user input port 22 is a female USB connector and the electrical connector 31 from an external memory storage device 31 is a corresponding male USB connector. In this way, the wireless headphone device 10 having a control circuit may communicate with the external memory storage device 31, wherein audio and other media data may be stored. The audio data, such as music, and media data, such as meta data like track length and playlists, (henceforth audio date) can be transferred from the external memory storage device 31 and played to the user through the wireless headphone device 10. In addition, the external memory storage device 31 can be removed from the user input port 22 and used with other electronic devices to download music or other audio data thereon. The external memory storage device 31 can then be rejoined with the user input port 22 so that the downloaded music or other audio data can be played through the wireless headphone device 10 without having to remove the wireless headphone device 10 from the user's head.

In the shown embodiment, the headband 13 includes an interior side 36 and exterior side 37, wherein the interior side 36 is configured to contact the head of a user and further includes a pad 38 for increased comfort. The pad 35 is integrally formed with the headband 13 and spans approximately the distance between the headphone housings. However, in alternative embodiments, the pad 35 is removably affixed to the headband 13 and may be selectively removed therefrom.

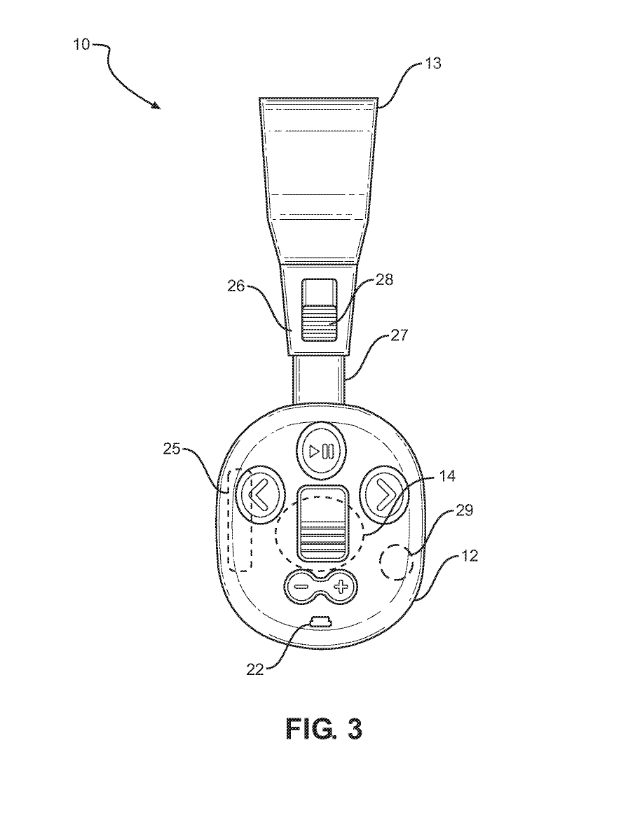

Referring now to FIG. 3, there is shown a side view of one embodiment of the present invention. The headphone housing 12 comprises a controller having one or more actuatable members operably connected to a processor that coordinates the actions of the headphone speakers 14. The wireless headphone device 10 may be powered via a power source 25, such as a rechargeable battery, disposed therein, or by an external power source (not shown) that is in electronic communication with the wireless headphone device 10 via a second user input port. In one embodiment, the user input port 22 is a female micro-USB port configured to receive a corresponding male micro-USB electrical connector and configured to transfer electrical power to the wireless headphone device 10.

In addition, the user input port 22 is operably connected to at least the processor, wherein audio data received from external memory storage may be transferred to the wireless headphone device 10. In one embodiment, the user input port 22 is configured to receive a thumb drive or other external memory storage having data, such as audio data. In another embodiment, a wireless transceiver 29 is also disposed within the headphone housing 12 and is operably connected to at least the processor, wherein audio data received from the wireless transceiver 29 may be transferred to the wireless headphone device 10.

Further, at least one of the ends of the headband 13 may comprise one or more elongated sections 26, 27. In the shown embodiment, a first elongated section 26 is adjustably secured to a second elongated section 27 so as to allow the headband 13 to extend into an extended configuration and retract into a retracted configuration. This telescopic arrangement of the elongated sections 26, 27 provides for adjustment of the linear length of the headband 13. The headphone housing 12 comprises the second elongated section 27 and the headband 13 comprises the first elongated section 26. The elongated sections 26, 27 are fastened to one another via any suitable fastener, such as a slide lock 28. The fastener allows a user to select the desired headband 13 length. In the illustrated embodiment, the elongated sections 26, 27 are tubular members comprising a rectangular cross-section, however in alternative embodiments, the elongated sections 26, 27 may comprise any suitable cross-sectional shape. The telescopic arrangement of the headband 13 enables the wireless headphone device 10 to easily fit a variety of users.

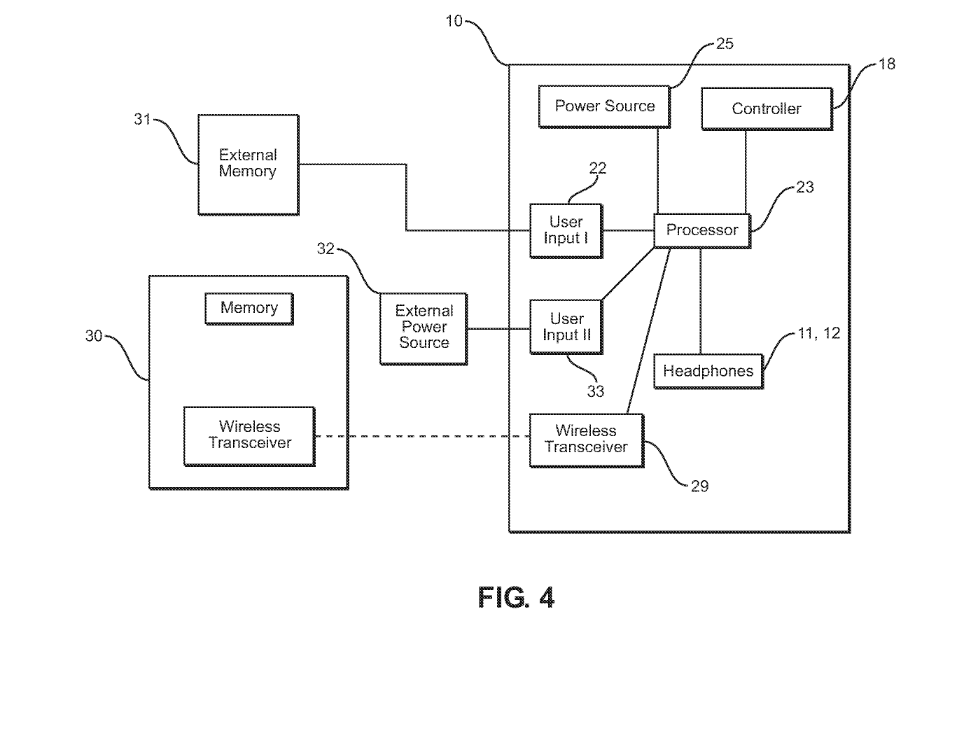

Referring now to FIG. 4, there is a schematic diagram of one embodiment of the present invention. The present invention includes a control circuit operably connecting the controller 18 to a processor 23, wherein the processor 23 coordinates the actions of the headphones 11, 12. The wireless transceiver 29 is operably connected to the processor and configured to receive audio data and a playback command from either a physically coupled external memory 31 or a remote wirelessly coupled electronic device 30. The processor 23 is configured to transfer audio data received from the transceiver to the speaker of the headphones 11, 12, resulting in an audible sound dispersed from the speaker.

In use, the wireless headphone device 10 may receive audio data from external memory storage 31 physically connected thereto, and from a remote electronic device 30 having a wireless transceiver configured to wirelessly connect to the wireless headphone device 10. In the event an external memory storage 31 physically connects to the wireless headphone device 10, then data transfers from the external memory storage 31 to the wireless headphone device 10 having internal memory storage. In one embodiment, the controller 18 includes internal memory storage. The data may remain on the controller 18 of the wireless headphone device 10 until directed by the processor 23 to output audible sound from the speakers of the headphone housings 11, 12. In another embodiment, an external power source 32 may couple to the wireless headphone device 10 via a second user input port 33. In other embodiments, the user input port 22 and the user input port 33 may be configured to receive both data and electrical power.

The wireless transceiver 29 is configured to receive audio data from a remote electronic device 30 by wirelessly coupling thereto via a group of transmission protocols including, but not limited to Bluetooth, UWB, RF, and IR. The data may remain on the internal memory storage of the wireless headphone device 10 until directed by the processor 23 to output audible sound from the speakers of the headphone housings 11, 12.

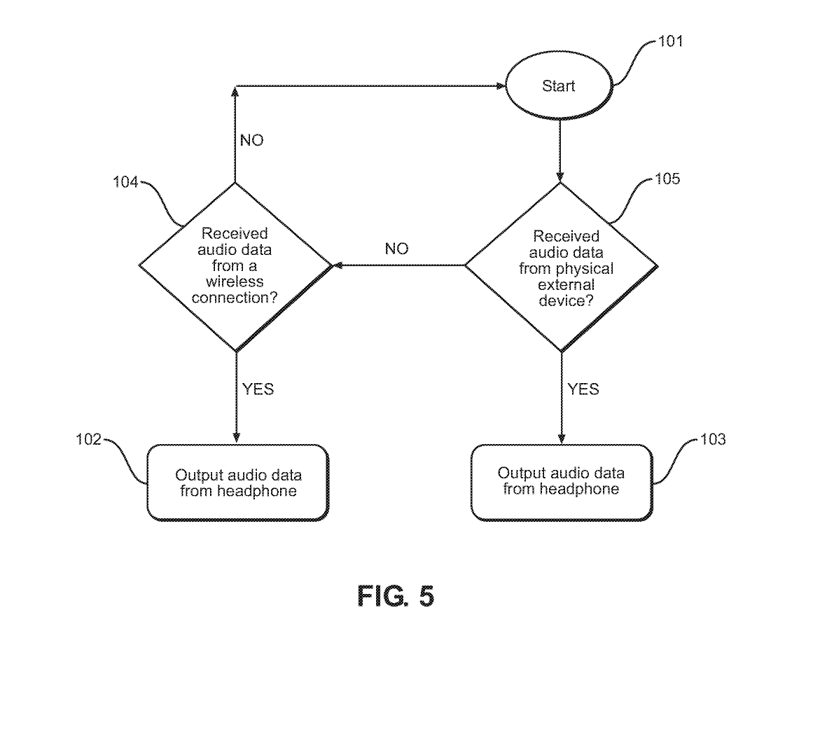

Referring now to FIG. 5, there is an exemplary flowchart of one process used to implement the functionality provided by the present invention. At the start of the process 101, the wireless headphone device is configured to receive audio data from external memory storage that is physically connected 102 thereto. If the wireless headphone device detects such a physical connection 102, then the headphone housings are directed to output audio data 103. If the wireless headphone device fails to detect a physical connection 102, then the wireless headphone device is directed to detect an audio data from a wireless connection 104. In response to receiving audio data from external memory storage that is physically connected 102 or from receiving audio data from a wireless connection 104, the headphone housings are directed to output audio data 103. The output of audio data 103 may need to be processed through the processor and downloaded to the internal memory storage of the wireless headphone device. The audio data may be outputted 103 through speakers positioned within the right and left wireless headphone device. The audio data may be outputted 103 separately to the left and right headphone housing, respectfully.

In an alternative process of implementing the functionality provided by the present invention, the steps of receiving audio data from a wireless connection 104 and receiving audio data from external memory storage that is physically connected 102 may be interchangeably and iteratively completed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless headphone device comprising:
one or more headphone housings, wherein each of the one or more headphone housings are configured to be positioned over an ear of a user;
wherein the one or more headphone housings comprise a control circuit operably connecting at least one audio speaker, at least one wireless transceiver, and at least one actuatable member;
wherein said wireless transceiver is configured to wirelessly receive audio data and playback commands from an external electronic device;
wherein said one or more actuatable members are configured for controlling the playback of the audio data;
wherein one or more audio speakers are configured to output audible sound based on the audio data.

2) The wireless headphone device of claim 1, further comprising:
one or more user input ports disposed on at least one headphone housing;
wherein the one or more user input ports are configured to receive a physical external memory storage device and enable electronic communication of audio data therebetween.

3) The wireless headphone device of claim 1, wherein:
at least one headphone housing having a proximal and lateral side;
wherein the proximal side includes an open end that provides access to an interior volume positioned adjacent to the speaker and configured to receive an ear of a user therein.

4) The wireless headphone device of claim 1, further comprising:
at least one internal memory storage device configured for the storing and playback of audio data.

5) The wireless headphone device of claim 1, further comprising:
at least one rechargeable power source disposed within one or more headphone housings configured to provide electrical power to the headphone housings.

6) The wireless headphone device of claim 1, wherein:
said one or more actuatable members are depressible buttons located on the one or more headphone housings configured to provide playback control functions of the audio data.

7) The wireless headphone device of claim 1, wherein:
the one or more headphone housings comprise a first headphone housing and a second headphone housing connected via a headband configured to be placed over a head of a user.

8) The wireless headphone device of claim 7, wherein:
the headband comprises a first elongated section telescoping receiving a second elongated section.

9) A method of using a headphone device, comprising the steps of:
utilizing a headphone device comprising a housing having a user input port, internal memory storage, and at least one speaker;
detecting a physical external memory storage device electronically coupled with said user input port, wherein the physical external memory storage device includes audio data;
downloading the audio data to the internal memory storage;
outputting the audio data from said speaker creating audio sound.

10) The method of claim 9, further comprising the steps of:
detecting audio data from a remote electronic device with a wireless transceiver;
downloading the audio data to the internal memory storage;
outputting the audio data from said speaker creating audio sound.
